(19) United States
(12) Patent Application Publication
(10) Pub. No.: US 2007/0005360 A1
(43) Pub. Date: Jan. 4, 2007

(54) Expanding the dynamic vocabulary of a speech recognition system by further voice enrollments

(75) Inventors: Harald Hüning, Blaustein (DE); Susanne Kronenberg, Ulm (DE); Michael Munz, Ulm (DE)

Correspondence Address: AKERMAN SENTERFITT, P.O. BOX 3188, WEST PALM BEACH, FL, 33402-3188, US

(73) Assignee: DaimlerChrysler AG

(21) Appl. No.: 11/478,928

(22) Filed: Jun. 30, 2006

(30) Foreign Application Priority Data
Jun. 30, 2005 (DE) 102005030965-842

(51) Int. Cl. G10L 15/04

(52) U.S. Cl. 704/251

(57) ABSTRACT

Problems frequently occur in particular in the addition of voice enrollments (speech patterns, with which the user himself can supplement the vocabulary of the speech recognition system) to broad word lists (dynamic vocabulary). For this reason, when the speech recognition system is in an expansion mode, the speech pattern expressed by the user is associated as new voice enrollment to the existing recognizer vocabulary of the speech recognition system. Herein the assignment should however be only preliminarily in a first step. The new speech pattern is intermediate stored in a memory. The recognizer is supplied with this intermediate stored pattern for a repeated recognition process, wherein this repeated process occurs not only on the basis of the preliminarily expanded recognizer vocabulary but also on the basis of the system commands. It is then determined on the basis of this recognition process, whether the speech pattern was recognized as element of the preliminarily expanded recognizer vocabulary or as element of the system command. If a system command was recognized, then this is carried out and the new voice enrollment is again removed from the recognizer vocabulary.

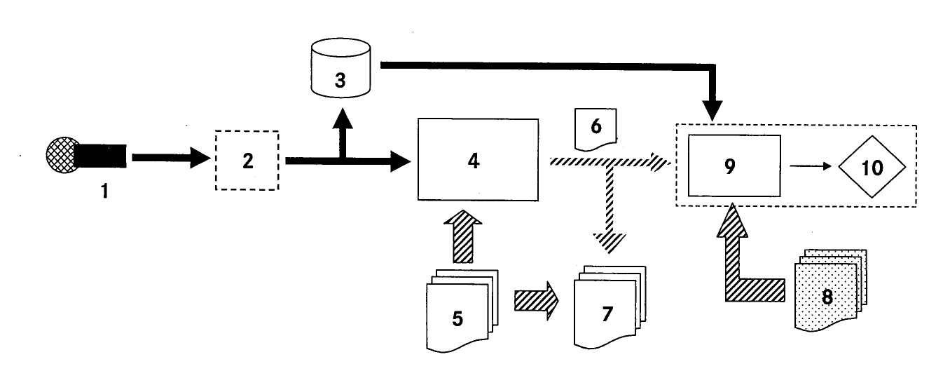

### BACKGROUND OF THE INVENTION

1. Field of the Invention

The invention concerns a process and a device suitable for carrying out the process for expanding the dynamic vocabulary of a speech recognition system by additional voice enrollments.

2. Description of the Related Art

Speech recognition systems include an input channel, generally a microphone, in order to record speech signals. The speech signals are successively so processed, that they are provided to a speech recognizer for recognition of individual words or word sequences. The recognition result is comprised therein of an association of the individual words or word sequences contained in the speech signal to entries in a word list associated with the speech recognition system. Frequently this word list includes, on the one hand, a group of system commands, via which the speech recognition system can be controlled, in particular for initiation of actions (for example: “start navigation” or “drive behind”) and on the other hand, a group of words (vocabulary), on which mostly event actions can be exercised, for example which more precisely define certain actions (for example: “Hamburg”> this vocabulary entry can, for example, using a system command, be selected as navigation goal: “Drive to Hamburg”).

From U.S. Pat. No. 5,231,670 A1 a speech recognition system is known, in which a speech signal is divided into system commands and text elements. Therein a system command describes a action to be carried out by the system, and the text element usually following within the speech signal represents a text upon which this action is to be applied. For this, it is proposed to separate the information contained in the command and text elements and separately, independently of each other, supply these to recognizers and process them. In this matter it becomes easier for the speech recognizer to associate the system commands or as the case may be text elements contained in the speech signal more clearly to elements of the respective word lists. The basic principal according to which the command and text elements are to be identified in the speech signal prior to the division thereof is, however, left open.

A process for identification of command and text elements in speech signals is described in European Patent EP 0 785 540 B1. For distinguishing, it is proposed to examine the individual elements of the speech signal as to the presence of a structure typical for command elements or text elements. In particular, it is proposed to observe the duration of speech pauses prior to or after the individual elements, wherefrom it is presumed, that a conclusion can be made as to the presence of a command element, if prior to and/or after the element a significant pause in speech is registered.

In particular, problems frequently occur in the addition of voice enrollments (speech patterns, with which the user himself can supplement the vocabulary of the speech recognition system) to broad word lists (dynamic vocabulary). This particularly in the case when the voice enrollment elements to be added to the new dynamic vocabulary are too similar to word elements contained in the predetermined vocabulary. This leads thereto, that subsequently in the framework of a speech recognition the word elements already originally contained in the dynamic vocabulary can be preferrentially recognized, without this being transparent or understandable by the system user. Also in the case of many embodiments of speech recognition systems the system user, during the input of new voice enrollments, finds himself in a dialog dead-end street; since if the system user has run into the type of dialog condition in which the system is to be trained with a new voice enrollment, then everything which he speaks in this condition is viewed as a voice enrollment to be trained. If the system user however has arrived at this dialog condition due to an operating error, then he cannot normally free himself from this condition by means of an additional speech input, since each system command used therefore is evaluated as desired input as a corresponding new voice enrollment.

### SUMMARY OF THE INVENTION

It is the task of the invention to provide a new type of process and a device suitable for carrying out the process for a speech recognition system, by means of which during the input of voice enrollments or dynamic vocabulary it can clearly distinguish between, on the one hand, a new voice enrollment to be added and, on the other hand, a system command. The task is solved by a process and a device for expanding the dynamic vocabulary of a speech recognition system with additional voice enrollments. Advantageous embodiments and further developments of the invention can be seen from the dependent claims.

The system for interaction with a speech recognition system is so designed, that the speech recognition system, by interaction with a system user, can be switched into an enhancement or expansion mode, wherein in this mode a list of voice enrollments (recognized vocabulary) associated with the list in the speech recognition system can be supplemented with additional speech patterns (voice enrollments). If the system is in this enhancement mood, then speech patterns can be fed in by the system user, which are then processed by a recognizer. Therein the speech pattern recognized by the recognizer as a new voice enrollment can be associated or assigned a recognizer vocabulary. In inventive manner, a speech pattern supplied by the system user is intermediate stored in a memory. Then a checking occurs to the extent as to whether the new speech pattern contains similarities with voice enrollments already contained in the recognizer vocabulary. If herein a substantial similarity between the speech pattern and an entry (voice enrollment) already present in the recognizer vocabulary is found, then it is not useful to include this speech signal as a new voice enrollment in the recognizer vocabulary, since this may frequently lead in later cases to errors in speech recognition. In this case, a recording of the speech signal in the recognizer vocabulary is barred. However, in the case that there is no great similarity to the entries in the recognizer vocabulary, then the speech pattern is evaluated as new voice enrollment and the recognizer vocabulary is at least primarily evaluated for a new voice enrollment. After this at least preliminary evaluation a temporary vocabulary is formed, which is either formed from the system commands and on the other hand either from the voice enrollment or from the supplementing recognizer vocabulary. Subsequently the intermediately stored speech pattern is provided to the recognizer for a repeated recognition process. Therein the repeated recognition process occurs on the basis of the temporary vocabulary. On the basis of the result of the new recognition process it is determined whether the speech pattern is recognized as system command or as new voice enrollment or, as the case may be, element of the preliminarily expanded recognizer vocabulary. In the case that the speech pattern is recognized with higher probability as element of the system command than as element of the dynamic vocabulary or, as the case may be, as new voice enrollment, then it will be appropriately interpreted by the speech recognition system as system command and subsequently the new voice enrollment is again removed from the expanded recognizer vocabulary.

The invention is accordingly comprised therein, that in a first step it is checked whether a speech signal supplied to the speech recognition system by a user has a high degree of similarity with elements of voice enrollments (recognizer vocabulary) already assigned (dedicated) in the system. If this similarity is large, it is not useful to enter the speech pattern as a new voice enrollment in the recognizer vocabulary, since the quality of the recognition results are negatively influenced thereby. If, however, a sufficient dissimilarity exists between the speech signal and the elements of the recognizer vocabulary, it would make sense to add the speech signal as a new voice element in the recognizer vocabulary. With the exception, that this speech signal is no new voice enrollment but rather a system command, so that an expansion of the recognizer vocabulary by the user was not intended. In order to check or test this, after a preliminary expansion of the recognizer vocabulary by the potentially new voice enrollment, a recognition process is initiated on the basis of the previously intermediately stored speech signal. The speech signal is examined in this recognition process on the basis of a temporary vocabulary, which is formed on the one hand by the combination of the system command and the new potential voice enrollment or, as the case may be, alternatively the thereby expanded recognizer vocabulary.

If in the operation of the recognizer the speech pattern is recognized with high probability as the new voice enrollment or as the case may be as an element of the dynamic vocabulary, rather than as element of the system command, then the assignment of the voice enrollment to the recognizer vocabulary, which until now had been preliminary, can be converted to a permanent assignment. In an alternative advantageous embodiment of the invention it is however conceivable to check, prior to the final assignment of the new voice enrollment to the recognizer vocabulary, whether in the case of the recognized element it is in fact the voice enrollment preliminarily assigned to the new recognizer vocabulary. Only in this case should a permanent1 assignment occur. In this special manner the invention is suited not only to expansion or as the case may be repeated checking to the extent whether a new voice enrollment to be recorded in the recognizer vocabulary is similar to vocabulary entries already contained in the dynamic recognizer.

In an advantageous matter the invention makes possible both the recognition of system commands during training of voice enrollments as well as also the recognition of system commands in association with very large dynamic vocabulary (recognizable vocabulary) in general. A decisive advantage is comprised therein, that by the invention the interaction between speech recognition system and its user can occur more intuitively. It is ensured, that the user can leave the dialog from any of the possible dialog conditions with pure voice means. Beyond this it is also made possible for the user to use words, in particular system commands, which he already knows from other locations or positions in the speech recognition system, in any of these dialog conditions.

### BRIEF DESCRIPTION OF THE DRAWNGS

In the following the invention will be described in greater detail with the aide of a FIGURE.

### DETAILED DESCRIPTION OF THE INVENTION

In general the speech signal is supplied to the speech recognition system via a microphone 1; of course an equivalent electronic transmission of the speech signal by means of a suitable electronic or software technical interface would be conceivable. It is thus conceivable in an advantageous manner that the signal thus entering the system if necessary is segmented by means of a OOV-Model 2. A process suitable therefore is described for example by T. Schaaf (Schaaf, T. (2001). “Detection of OOV Words Using Generalized Word Models and a Semantic Class Language Model”, EuroSpeech, Aalborg). An OOV Model is converted into a speech signal by the speech recognition system in the same way as an individual word, with the difference, that it is not specifically responding to a individual predefined word. Therewith it is possible to form a series of spoken words into an individual speech signal. The recognition of an OOV-Word within a longer spoken expression enables the determination of the time boundary, whereupon in most cases this OOV-Word is extracted and used in further processing in the speech recognition system, or in the further course of the speech recognition process, in the sense of an individual word.

The speech signal delivered to the speech recognition system, or as the case may be the OOV-Word extracted by means of the OOV-Model 2, is intermediate stored in a memory 3 and on the other hand supplied to a comparator unit 4. By means of this comparator unit 4 the supplied speech signal is examined with regard to whether it has substantial similarity to voice enrollments (recognizer vocabulary) 5 already assigned in the speech recognizer. If no great similarity exists, then the speech signal is evaluated as a new voice enrollment 6 and further processed. In the framework of the further processing thereof, among other things the recognizer vocabulary 5 as it has been until now is at least preliminarily expanded by the voice enrollment 6 to form a new recognizer vocabulary 7. In order now to check whether this potential new voice enrollment 6 is in fact a voice enrollment or whether the speech signal is to be assigned to a system command, a temporary vocabulary is formed for a subsequent running of the recognizer. This temporary recognizer vocabulary is compiled from the system commands 8 and alternatively either from the new voice enrollment 6 (as shown in the FIG.) or alternatively the further recognizer vocabulary 7. The speech signal intermediate stored in the memory 3 is now supplied to the recognizer 9, so that it can provide a recognition result 10 on the basis of the temporary vocabulary. Of course the recognizer 9 can also be so designed, that it provides multiple entries as result 10 of the temporary vocabulary. For this, it is conceivable in advantageous matter to so design the recognizer that, in order to enable a better quality judgment, the individual recognition results are assigned recognition probabilities, in particular confidence values. With the aide of these probabilities then, using suitable processes known in the state of the art, an evaluation and targeted selection of recognition results can occur. On the basis of the results 10 of the new recognition process it is then evaluated or judged, in so far that the speech pattern is recognized as element of the system command 8 or as the new voice enrollment 6 or as the case may be element of the expanded recognizer vocabulary 7. Beginning with this evaluation, the speech recognition system interprets the speech pattern as system command in the case that this is evaluated with higher probability as element of the system command 8 than as new voice element 6, or on the other hand as element of the recognizer vocabulary 7. Likewise in this case the voice enrollment 6 is again removed from the recognizer vocabulary of the system.

Particularly advantageous for the intuitive interaction of the user with a speech recognition system is when this system informs the user with regard to whether it has in certain cases again removed from this vocabulary a voice enrollment 6 which had been preliminarily associated with the recognizer vocabulary 5. It makes sense to implement this information strategy in particular when the removal from the recognizer vocabulary occurs for the reason of too strong a similarity to the existing entries.

1. A process for interaction with a speech recognition system, in which the speech recognition system is switched by interaction with a system user into a expansion mode, wherein in this mode the list of voice enrollments (recognizer vocabulary) assigned in the speech recognition system is supplemented with additional speech patterns (voice enrollments), comprising:
supplying the system with a speech pattern expressed by a user;
intermediate storing the speech pattern;
processing the speech pattern by means of a recognizer,
comparing the speech pattern for the existence of similarities with entries in the recognizer vocabulary (5) using a comparator unit (9),
wherein, in the case that the new speech pattern does not have to great similarity to the entries in the recognizer vocabulary (5), evaluating this as new voice enrollment (6) and at least preliminarily expanding the recognizer vocabulary (5) therewith,
after this at least preliminary expansion forming a temporary vocabulary, which is formed on the one hand from the system command (8) and on the other hand either from the new voice enrollment (6) or from the preliminarily expanded recognizer vocabulary (7),
subsequently supplying the recognizer (9) with the intermediate stored speech pattern for a repeated recognition process, wherein this repeated recognition process occurs on the basis of the temporary vocabulary,
wherein on the basis of the result (10) of the new recognition process it is determined whether the speech pattern is recognized as system command (8) or as new voice enrollment (6) or, as the case may be, element of the preliminary expanded recognizer vocabulary (7),
and wherein in the case that the speech pattern is recognized with higher probability as element of the system command (8) than as element of the expanded recognizer vocabulary (7) or, as the case may be, as new voice enrollment (6), it is subsequently interpreted by the speech recognition system appropriately as system command and it is again removed from the expanded recognizer vocabulary (7).

2. The process according to claim 1, wherein when the speech pattern is recognized with higher probability as new voice enrollment (6) it is permanently associated with the recognizer vocabulary (5).

3. The process according to claim 1, wherein when the speech pattern is recognized with high probability as element of the preliminary expanded recognizer vocabulary (7) it is finally assigned to the recognizer vocabulary (5) only then, when this element is the preliminarily newly in the recognized vocabulary (7) assigned voice enrollment (6).

4. The process according to claim 1, wherein for quality determination the recognizer (9) provides probabilities, with respect to its recognition results.

5. The process according to claim 1, wherein the speech pattern is supplied to the speech recognition system by speaking into a microphone (1).

6. The process to claim 1, wherein the system user is informed with regard to when these speech patterns supplied to the speech recognition system has not been permanently assigned to its vocabulary.

7. A device for interaction with a speech recognition system, the speech recognition system including an expansion mode, which is activated by interaction with a system user, wherein in this mode the list of voice enrollments (recognizer vocabulary) associated with the speech recognition system can be expanded by additional speech patterns (voice enrollments), wherein for this a speech pattern is supplied to the system by the user via a microphone (1) and is processed by means of a recognizer (9),
and in which the speech pattern recognized by the recognizer is assigned as new voice enrollment to the previously existing dynamic vocabulary of the speech recognition system (5),
said device including:
a memory (3) in which the speech pattern supplied by the user is intermediate stored,
a comparison (4) by means of which the supplied speech pattern is compared with the voice enrollments of the recognizer vocabulary (5) wherein then in the case that no to grade a similarity to the entries in the recognizer vocabulary (5) exists, this is preliminarily assigned to the recognizer vocabulary (5) as new voice enrollment, so that a further vocabulary (7) is produced,
a temporary vocabulary, which is formed on the one hand by the systems commands (8) and on the other hand by the preliminarily expanded recognizer vocabulary (7) or the new voice enrollment (6),
a recognizer (9) is provided, which works on the basis of this temporary vocabulary, and which is supplied with the speech pattern intermediate stored in the memory (3) for a repeated recognition process,
and an evaluation unit (10), which evaluates on the basis of the results of the new recognition process, to what extent the speech pattern was recognized as system command (8) or as element of the preliminary expanded dynamic vocabulary (7) or as the case may be as new voice enrollment (6) and which then, when the speech pattern was recognized with higher probability as element of the speech command (8) then as element of the dynamic vocabulary (7) as the case may be as the new voice enrollment (6), it is subsequently interpreted by the speech recognition system appropriately as system command and it is again removed from the expanded recognition vocabulary.

8. The process according to claim 1, wherein t when the speech pattern is recognized with higher probability as element of the preliminary expanded recognizer vocabulary (7), it is permanently associated with the recognizer vocabulary (5).

9. The process according to claim 1, wherein for quality determination the recognizer (9) provides confidence values with respect to its recognition results.
